(19) United States
(12) Patent Application Publication
(10) Pub. No.: US 2006/0131440 A1
(43) Pub. Date: Jun. 22, 2006

(54) Method and apparatus for dispersing small particles in a matrix

(75) Inventor: Shih-Chieh Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/283,200

(22) Filed: Nov. 18, 2005

(30) Foreign Application Priority Data
Dec. 2, 2004 (CN) 200410077290.6

(51) Int. Cl. B05B 1/08

(52) U.S. Cl. 239/102.2

(57) ABSTRACT

An apparatus for dispersing particles (e.g., nanoparticles) in a matrix includes a container (11), an agitating device (12), an ultrasonic vibrating device (15), a heating device (18), and a holder (19). The container is configured for containing the particles and a surfactant (22), while the agitating device is adapted to extend into the container and is thus configured for agitating the particles with the surfactant. The ultrasonic vibrating device is connected to the container and is able to receive a mixture of the particles and the surfactant. The ultrasonic vibrating device is configured for sufficiently dispersing the particles in the surfactant to form a dispersion. The holder is configured for receiving a fluid (i.e., the dispersion) from the ultrasonic vibrating device and for retaining a matrix material therein. The heating device is configured for evaporating the surfactant.

### BACKGROUND OF THE INVENTION

1. Field of the Invention

The present invention relates generally to a method and apparatus for dispersing particles having very fine size in a matrix and, more particularly, to a method and apparatus for dispersing small particles in a thermal conductive matrix by means of ultrasonic vibrations.

2. Description of Related Art

Nano-particles, such as granulated particles, nano-fibers, and nanotubes are in increasing demand due to their distinct, advantageous properties. However, due to the Van der Waals forces associated therewith, when a grain size of such nano-particles is reduced to a certain level, such particles are likely to agglomerate together. For example, granulated nano-particles having a diameter or size less than 1 micrometer are very likely to agglomerate. The agglomeration of the particles lowers their unique functionalities and properties.

It is already known that thermal conductive particles having micro-scaled and/or nano-scaled sizes can be doped into a thermal conductive matrix to thereby result in a thermal interface material with an enhanced thermal conductivity. For example, metallic granulated nano-particles (such as silver and copper nano-particles) and/or carbon nanotubes may be incorporated into a thermal interface material, and the resultant product has a thermal conductivity of at least several times of the original one. In order to maintain their unique and distinct properties in the thermal interface material, the granulated nano-particles and the carbon nanotubes need to be dispersed uniformly without being agglomerated in the thermal interface material.

A conventional method for orienting and dispersing carbon nanotubes in a thermal interface material is disclosed. The method includes steps of: preparing a composite slurry of carbon nanotubes in a liquid polymer, aligning the carbon nanotubes in the composite by applying an electrostatic field; and curing the composite while continuing to apply the electrostatic field. This method is adapted for dispersing carbon nanotubes, which have a great aspect ratio, in a composite polymer along a direction of the electrostatic field. However, this method is not suitable for the granulated particles.

Therefore, what is needed is a method and apparatus for uniformly dispersing granulated nanoparticles and/or even other materials in a matrix.

### SUMMARY

In a preferred embodiment, an apparatus for dispersing particles (e.g., nanoparticles) in a matrix includes a container, an agitating device, an ultrasonic vibrating device, a heating device, and a holder. The container is configured for containing the particles and a surfactant, while the agitating device is adapted to extend into the container and is thus configured for agitating the particles with the surfactant. The ultrasonic vibrating device is connected to the container and is able to receive a mixture of the particles and the surfactant. The ultrasonic vibrating device is configured for sufficiently dispersing the particles in the surfactant to form a dispersion. The holder is configured for receiving a fluid (i.e., the dispersion) from the ultrasonic vibrating device and for retaining a matrix material therein. The heating device is configured for evaporating the surfactant.

In addition, a method for dispersing particles in a matrix is provided. The method includes the steps of
a) providing an amount of particles and a surfactant in a container, the particles being nano-scaled in size;
b) providing a matrix material in a holder;
c) agitating the particles and the surfactant in the container, therefore forming a suspension having the particles preliminarily dispersed in the surfactant;
d) introducing the suspension to an ultrasonic vibrating device and conducting an ultrasonic vibrating process, thereby forming a dispersion having the particles sufficiently dispersed in the surfactant;
e) introducing the dispersion to the holder;
f) mixing the dispersion and the matrix held in the holder; and
g) heating the dispersion and the matrix for evaporating the surfactant.

Beneficially, the particles include carbon nanocapsules, carbon nanotubes, and/or metallic nanopowders.

Usefully, the surfactant is a cationic surfactant, an anionic surfactant, or a mixture thereof. The cationic surfactant may be, e.g., cetyltrimethylammonium bromide. The anionic surfactant can, for example, be sodium dodecyl sulfate.

The matrix according the embodiment is a thermally conductive material, such as a silver colloid, thermal grease, and/or silicone.

The method for dispersing the particles in the matrix of any of the described embodiments has the following advantages. Firstly, the particles are dispersed in the matrix uniformly without agglomeration, due to the auxiliary surfactant. Secondly, the surfactant used for facilitating the dispersing is evaporated in the final step. As such, the properties of the particles are not deteriorated. Thirdly, the method is easy to implement, and the costs associated therewith are inexpensive.

Other advantages and novel features will become more apparent from the following detailed description of preferred embodiments when taken in conjunction with the accompanying drawings.

### BRIEF DESCRIPTION OF THE DRAWINGS

Many aspects of the present apparatus and method for dispersing particles can be better understood with reference to the following drawings. The components in the drawings are not necessarily to scale, the emphasis instead being placed upon clearly illustrating the principles of the present apparatus and method. Moreover, in the drawings, like reference numerals designate corresponding parts throughout the several views.

FIG. 1 is a schematic, frontal view of an apparatus for dispersing particles in a thermal conductive matrix, according to a first preferred embodiment; and

FIG. 2 is a flowchart demonstrating a method for dispersing particles in a thermal conductive matrix, according to a first preferred embodiment.

The exemplifications set out herein illustrate at least one preferred embodiment of the present method and apparatus for dispersing particles, in one form, and such exemplifications are not to be construed as limiting the scope of the invention in any manner.

### DETAILED DESCRIPTION OF PREFERRED EMBODIMENTS

Reference will now be made to the drawings to describe preferred embodiments of the present method and apparatus for dispersing particles, in detail.

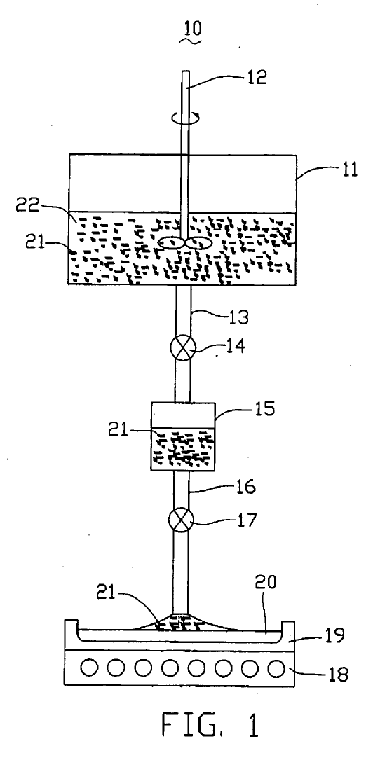

Referring to FIG. 1, an apparatus 10 for dispersing particles according to a first preferred embodiment includes a container 11, an ultrasonic shaker 15 connected with the container 11, and a holder 19 connected with the ultrasonic shaker 15.

The container 11 is, for example, rectangular, cylindrical or funnel-formed, and is used for containing a surfactant/dispersant 22 and particles 21 (e.g., nanoparticles) to be initially suspended and, later, dispersed therein. An agitator 12 extends inside the container 11 and is thus positioned and configured therein for agitating the combination of the surfactant/dispersant 22 and particles 21 carried in the container 11. It is to be understood that the agitator 12 may either be permanently mounted inside the container 11 or be selectively movable relative thereto. It is to be further understood that the agitator 12, including the driving mechanism thereof, could, instead, be mounted entirely within the container 11 and not necessarily partially extend there out of

A first pipe 13 is adapted to fluidly connect the container 11 with the ultrasonic shaker 15. A first valve 14 is attached within the first pipe 13, and is configured for shifting between an open position and a closed position. Accordingly, the first valve 14 is adapted for selectively controlling a flow rate through the first pipe 13. Preferably, a first end of the first pipe 13 is connected to a bottom of the container 11, while an opposite second end of the first pipe 13 is connected to a top of the ultrasonic shaker 15. The ultrasonic shaker 15 is configured for further vibrating the mixture of the particles 21 and the surfactant/dispersant 22 in order to more uniformly distribute/disperse the particles 21 within the surfactant/dispersant 22, the particles 21 thereby becoming substantially uniformly dispersed within the surfactant/dispersant 22. The degree of dispersion is sufficient to deter the formation of agglomerates of the particles 21. It is to be understood that ultrasonic shaker 15 could be designed such that the entire device generates the ultrasonic vibrations associated therewith or such that one particular element or set of elements associated therewith is configured for vibration generation.

The holder 19 is used for holding a matrix 20, such as a thermal conductive matrix material. A second pipe 16 connects the ultrasonic shaker 15 with the holder 19. A second valve 17 is attached within the second pipe 16 and can be selectively shifted between an open position and a closed position. As such, the second valve 17 is configured for controlling a flow rate through the second pipe 16. Preferably, a first end of the second pipe 16 is connected to a bottom of the ultrasonic shaker 15, and an opposite second end of the second pipe 16 is extended adjacent/proximate a bottom of the holder 19. As such, the second pipe 16 is configured for conveying a fluid (e.g., a liquid suspension/dispersion) from the ultrasonic shaker 15 to the holder 19.

Preferably, the apparatus 10 further includes a heating device 18. The holder 19 is placed on the heating device 18. The heating device 18 is controllably heated in a manner that facilitates the evaporation of the surfactant/dispersant 22. While the embodiment illustrated indicates the holder 19 to be mounted on the heating device 18, it is to be understood the heating device 18, if relying on thermal conductance to heat the holder 19, could be mounted to the holder 19 in various ways and still sufficiently heat and, if needed, support the holder 19. If the heating device 18 is not needed to support the holder 19, the heating device 18 could rely on other forms of heating (e.g., radiation or convection) that do not even rely on contact therebetween. As such, the heating device 18 may only need to be proximate the holder 19 to achieve its primary function of causing a temperature increase in the holder 19 and its contents.

Advantageously, the holder 19 is an agitating device or an emulsifying machine adapted to receive and agitate a composite material/mixture (i.e., matrix 20 and particles 21, along with surfactant/dispersant 22) received therein. Such an agitating device would aid in maintaining the dispersion of the particles 21 relative to the matrix 20 and would promote the evaporation of the surfactant/dispersant 22.

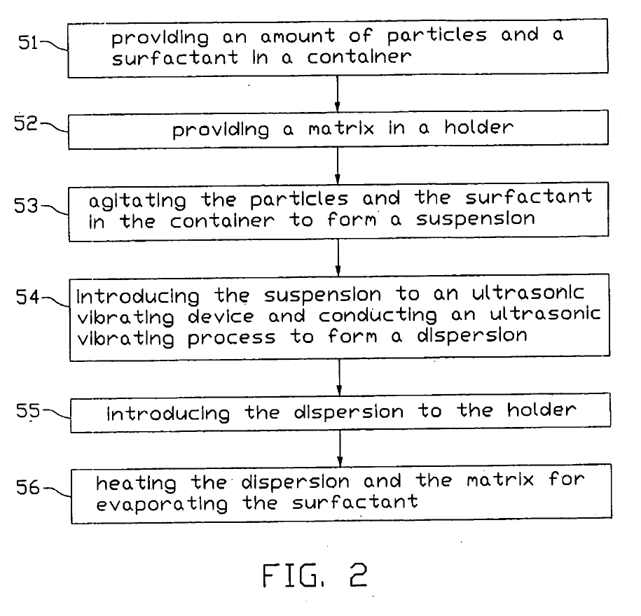

Referring to FIGS. 1 and 2, a method for dispersing particles in a matrix using the apparatus 10 includes the following steps:
Step 51: introducing an amount of particles 21 and a surfactant 22 into the container 11. The particles 21 can be nano-scaled or micro-scaled particles, for example, carbon nanocapsules, carbon nanotubes, powder of a metal, boron nitride particles, etc. The surfactant can be a cationic surfactant, such as cetyltrimethylammonium bromide (CTAB), and/or an anionic surfactant, such as sodium dodecyl sulfate (SDS).
Step 52: providing a matrix in the holder 18. The matrix 20 is composed of, for example, a thermal conductive material, such as a silver colloid, a thermal grease, silicone, etc.
Step 53: agitating the particles 21 and the surfactant 22 by the agitator 12 for a period of time. Therefore, a suspension having the particles 21 preliminarily mixed in the surfactant 22 is obtained. Preferably, the agitating step lasts for about 5 minutes.
Step 54: introducing the suspension into the ultrasonic shaker 15 via the first pipe 13 and the first valve 14 and conducting an ultrasonic vibrating process. As a result, a dispersion having the particles substantially uniformly dispersed in the surfactant 22 is obtained. Preferably, the ultrasonic vibrating process can be operated for about 3˜10 minutes, and more preferably for about 5 minutes. Thus, the particles 21 are essentially fully dispersed in the surfactant 22, and the potential for the agglomeration phenomenon is eliminated.
Step 55: introducing the dispersion, having the particles 21 substantially uniformly distributed in the surfactant 22, into the holder 19 via the second pipe 16 and the second valve 17 and then mixing the dispersion with the matrix 20 held in the holder 19. Preferably, the holder 19 is further configured as an agitating device or an emulsifying machine, and the matrix 20 can thereby be agitated and mixed with the particles 21.
Step 56: heating the matrix 20 and the dispersion mixed therewith using the heating device 18 until the surfactant 22 is completely evaporated. Therefore, a composite having the particles 21 uniformly dispersed in the matrix 20 is obtained. The mixing of the matrix 20 and the dispersion may occur before and/or during heating thereof. The mixing procedure may be enhanced by the agitation of the holder 19, if so configured.

In this embodiment, the resultant composite can be used as a thermal interface material having an enhanced thermal conductivity. It is understood that the above apparatus and method are also suitable for dispersing other particles having different functionalities and properties within desired matrixes for preparing desired composites. While especially useful for dispersing nanomaterials in a matrix to help deter reagglomeration thereof, it is to be understood that any of a variety of shapes and sizes of particles could be distributed within in a matrix material using the present apparatus/process.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. An apparatus comprising:
a container;
an agitating device operably positioned within the container;
an ultrasonic vibrating device fluidly connected to the container;
a holder in fluid communication with the ultrasonic vibrating device; and
a heating device mounted proximate the holder, the heating device being configured for heating the holder.

2. The apparatus as claimed in claim 1, further comprising a first pipe and a first valve mounted within the first pipe, the ultrasonic vibrating device being connected to the container via the first pipe.

3. The apparatus as claimed in claim 1, further comprising a second pipe and a second valve mounted within the second pipe, the holder being configured for receiving a fluid conveyed from the ultrasonic vibrating device via the second pipe.

4. The apparatus as claimed in claim 1, wherein the holder is one of an agitating device and an emulsifying machine adapted for containing and agitating a material received therein.

5. A method for dispersing particles in a matrix, comprising steps of:
providing an amount of particles and a surfactant in a container;
agitating the particles and the surfactant in the container, therefore forming a suspension having the particles preliminarily dispersed in the surfactant,
introducing the suspension to an ultrasonic vibrating device and conducting an ultrasonic vibrating process, therefore forming a dispersion having the particles substantially uniformly dispersed in the surfactant;
providing a matrix in a holder;
introducing the dispersion to the holder;
mixing the dispersion and the matrix held in the holder; and
heating the dispersion and the matrix in order to evaporate the surfactant.

6. The method as claimed in claim 5, wherein the particles comprise at least one of carbon nanocapsules, carbon nanotubes, and metallic powders.

7. The method as claimed in claim 5, wherein the surfactant comprises at least one of a cationic surfactant and an anionic surfactant.

8. The method as claimed in claim 7, wherein the surfactant comprises a cationic surfactant, the cationic surfactant being cetyltrimethylammonium bromide.

9. The method as claimed in claim 7, wherein the surfactant comprises an anionic surfactant, the anionic surfactant being sodium dodecyl sulfate.

10. The method as claimed in claim 5, wherein the agitating step is operated for 5 minutes.

11. The method as claimed in claim 5, wherein the ultrasonic vibrating process is operated for about 3˜10 minutes.

12. The method as claimed in claim 11, wherein the ultrasonic vibrating process is operated for about 5 minutes.

13. The method as claimed in claim 5, wherein the matrix is composed of a thermal conductive material.

14. The method as claimed in claim 13, wherein the thermal conductive material comprises at least one of a silver colloid, a thermal grease, and silicone.

15. The method as claimed in claim 5, wherein the dispersion and the matrix held in the holder are agitated during the mixing thereof
